(19) United States
(12) Patent Application Publication
(10) Pub. No.: US 2014/0208897 A1
(43) Pub. Date: Jul. 31, 2014

(54) RATCHET WRENCH

(71) Applicant: JOHN METAL TOOLS INDUSTRIAL LTD., Taichung (TW)

(72) Inventor: Chien-Chuan Kao, Taichung (TW)

(73) Assignee: JOHN METAL TOOLS INDUSTRIAL LTD., Taichung (TW)

(21) Appl. No.: 13/752,514

(22) Filed: Jan. 29, 2013

(51) Int. Cl. B25B 13/46

(52) U.S. Cl. CPC B25B 13/463
USPC 81/63

(57) ABSTRACT

A ratchet wrench includes a body having a head portion, a handle portion extended from one end of the head portion, a first cavity and a second cavity mutually communicated in the head portion, a rotatable member rotatably accommodated in the first cavity having sloping teeth around the periphery thereof, a reversing member pivotally mounted in the second cavity defining opposing first and second bearing surfaces, a pawl set between the rotatable member and the reversing member having a shaft portion located between the first and second bearing surfaces and movable by the reversing member between first and second positions to force a toothed portion opposite with the shaft engaged with or disengaged from the sloping teeth, and a cover covering the cavities having a through hole for the passing of the rotatable member to rotate a wrench socket forward or backward.

### BACKGROUND OF THE INVENTION

1. Field of the Invention

The present invention relates to wrenches and more particularly, to a new design of ratchet wrench.

2. Description of the Related Art

U.S. Pat. No. 7,353,735 discloses a ratchet wrench 10, which includes a body 12 with a head portion 14 and a handle portion 16. The head portion 14 includes a cavity 18 that is adapted to accommodate a rotatable member 20, a reversing member 22, and a pawl 24. The rotatable member 20 has a plurality of teeth 30 disposed around a circumferential surface thereof. The rotatable member 20, the reversing member 22, and the pawl 24 interact with one another to provide a wrench that allows the rotatable member 20 to rotate in only one direction, depending on the position of the reversing member 22. Further, the cavity 18 is covered by a cover 110.

To achieve reversing between forward driving and backward driving, the pawl 24 is milled to provide a cam surface 92 and a protrusion 96. This cam surface 92 interacts with a plunger 68 and a spring 66 of the reversing member 22 as the reversing member 22 rotates. However, processing the pawl 24 to form the cam surface 92 and the protrusion 96 requires high precision. The processing procedure is complicated and thereby increasing the cost. Further, the reversing member 22 is adapted to link the pawl 24 with the tines 70 thereof for receiving the protrusion 96 of the pawl 24. The pawl 24 can simply use its one side to support the tines 70 of the reversing member 22. This design has low structural strength, affecting the lifespan of the ratchet wrench. Therefore, there is room for improvement.

### SUMMARY OF THE INVENTION

The present invention has been accomplished under the circumstances in view. It is the main object of the present invention to provide a ratchet wrench, which has two opposing bearing surfaces defined in a reversing member thereof for supporting a shaft portion of a pawl, enhancing component connection tightness and structural strength.

To achieve these and other objects of the present invention, a ratchet wrench comprises a body, which comprises a head portion defining therein a first cavity and a second cavity in communication with each other and a handle portion extended from one end of the head portion, a rotatable member, which is rotatably accommodated in the first cavity and comprises a plurality of sloping teeth equiangularly spaced around the periphery thereof, a reversing member, which is pivotally mounted in the second cavity and comprises opposing first bearing surface and second bearing surface, a pawl, which is set between the rotatable member and the reversing member and comprises a toothed portion located at one side thereof and a shaft portion located at an opposite side thereof and disposed between the first bearing surface and the second bearing surface and, which is movable by the reversing member between a first position where the toothed portion of the pawl is forced into engagement with the sloping teeth of the rotatable member and a second position where the toothed portion of the pawl is disengaged from the sloping teeth of said rotatable member, and a cover covering the first cavity and the second cavity and defining therein a through hole for the passing of the rotatable member to rotate a wrench socket forward or backward.

Thus, by means of accommodating the shaft portion of the pawl in the space between the first bearing surface and second bearing surface of the reversing member, the structural strength of the ratchet wrench is enhanced. Further, a locating pin is mounted in the backside of the pawl, enabling the pawl to be positively supported on the spring member during reversing of the rotatable member. Subject to the arrangement of the locating pin, it is not necessary to process a part of the pawl into a cam surface by means of a complicated milling procedure, and therefore, the manufacturing cost of the ratchet wrench can be greatly reduced.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is an elevational view of a ratchet wrench in accordance with the present invention.

FIG. 2 is an exploded view of the ratchet wrench in accordance with the present invention.

FIG. 3 corresponds to FIG. 2 when viewed from another angle.

FIG. 4 is a sectional view taken along line4-4 of FIG. 1.

FIG. 5 is a schematic sectional view of the present invention, illustrating the reversing member in the first position.

FIG. 6 is a schematic sectional view of the present invention, illustrating the reversing member in the second position.

### DETAILED DESCRIPTION OF THE PREFERRED EMBODIMENT

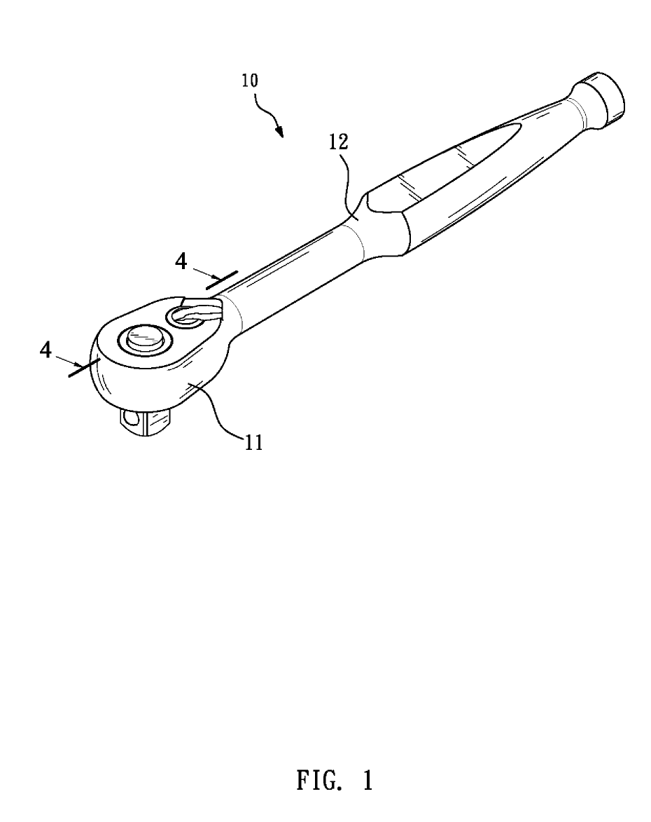

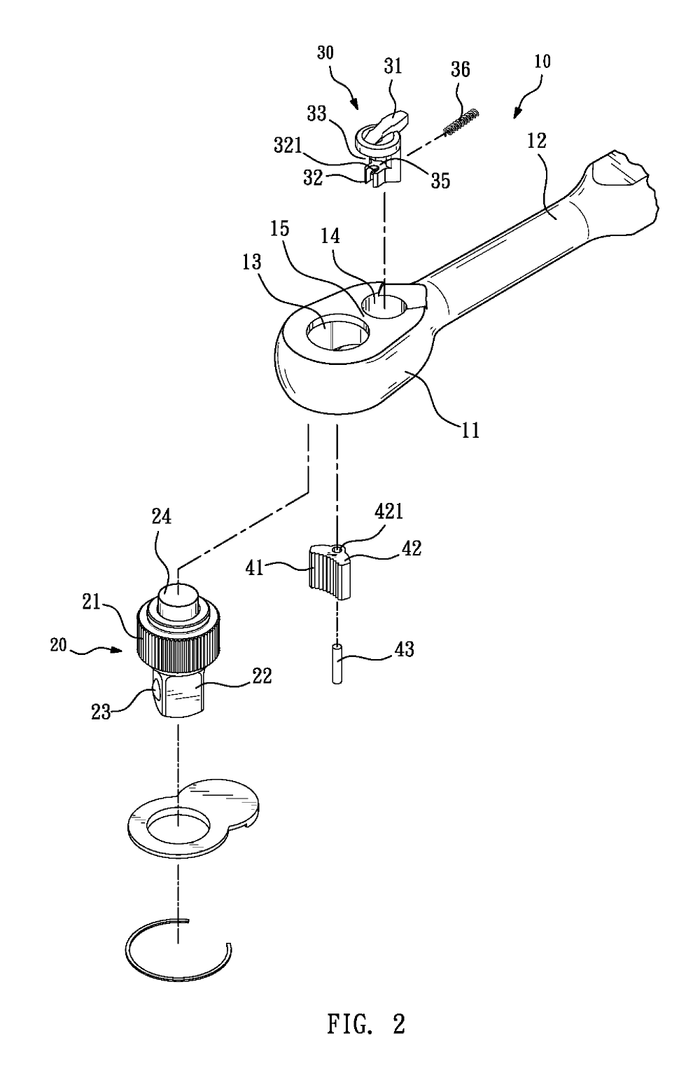

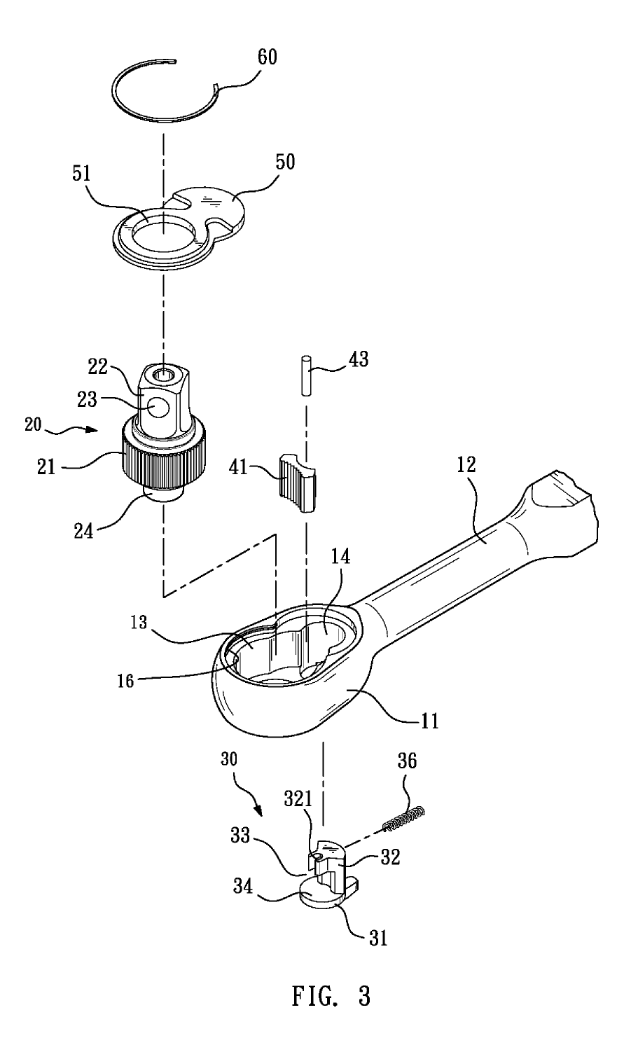

Referring to FIGS. 1 to 3, a ratchet wrench in accordance with the present invention is shown. The ratchet wrench comprises a body 10, a rotatable member 20, a reversing member 30, a pawl 40, a cover 50, and a C-shaped retainer 60.

The body 10 comprises a head portion 11 and a handle portion 12 that extends from one end of the head portion 11. The head portion 11 defines therein a first cavity 13 and a second cavity 14 that extend through opposing top and bottom sides of the head portion 11 and are disposed in communication with each other, a connection rib 15 located at the top side of the head portion 11 between the first cavity 13 and the second cavity 14, and a locating groove 16 located at the bottom side of the head portion 11 around the first cavity 13.

The rotatable member 20 is rotatably accommodated in the first cavity 13, comprising a plurality of sloping teeth 21 equiangularly spaced around the periphery thereof, a rectangular coupling rod 22 extended from a bottom side thereof, a steel ball 23 mounted in one side of the rectangular coupling rod 22, and a release control rod 24 located at a top side thereof and operable to move the steel ball 23 between a locking position and a release position.

The reversing member 30 is pivotally mounted in the second cavity 14 and movable between a first position and a second position. The reversing member 30 comprises a finger rod 31 located at one end thereof that can be grasped by the user to bias the reversing member 30 between the first position and the second position, a fork 32 located at a bottom side of an opposite end thereof, a receiving space 33 defined between a first bearing surface 34 at the bottom side of the finger rod 31 and a second bearing surface 35 at the top side of the fork 32, and a through hole 321 transversely extending through the fork 32 and holding a spring member 36 therein.

The pawl 40 is set between the rotatable member 20 and the reversing member 30, comprising a toothed portion 41 located at one side thereof, a shaft portion 42 located at an opposite side thereof. The pawl 40 is movable by the reversing member 30 between the aforesaid first position and second position to engage or disengage from the sloping teeth 21 of rotatable member 20. Further, the pawl 40 is accommodated in the receiving space 33 of the reversing member 30, keeping the shaft portion 42 in between the first bearing surface 34 and the second bearing surface 35. Further, an axle hole 421 extends through the shaft portion 42 for the insertion of a locating pin 43. The fork 32 of the reversing member 30 is coupled to the locating pin 43 The spring member 36 is mounted in the through hole 321 of the fork 32 and stopped between the periphery of the locating pin 43 and the inside wall of the second cavity 14.

The cover 50 covers the first cavity 13 and the second cavity 14, defining therein a through hole 51 for the passing of the rectangular coupling rod 22 of the rotatable member 20 for rotating a wrench socket (not shown) forward or backward.

The C-shaped retainer 60 is mounted in the locating groove 16 of the head portion 11 of the body 10 to prevent the cover 50 from falling out of the head portion 11 of the body 10.

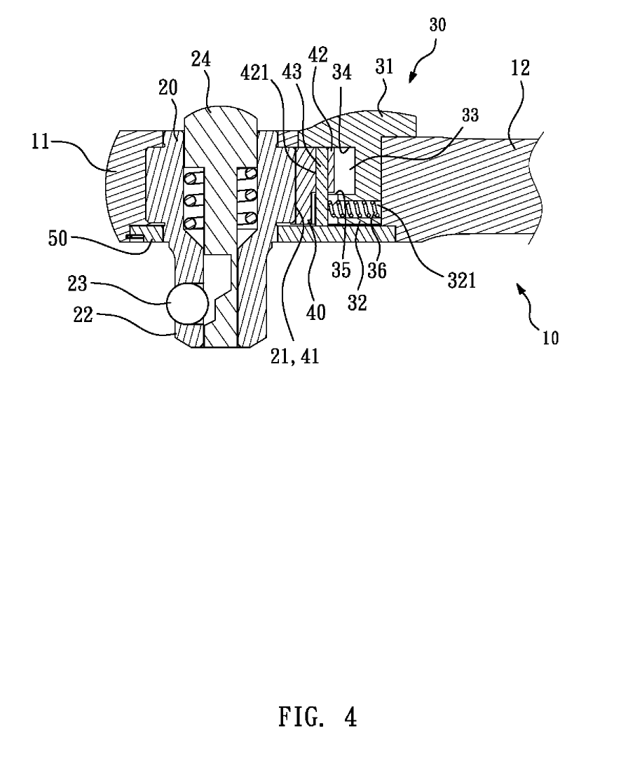

FIG. 4 is a sectional view taken along line4-4 of FIG. 1. As illustrated, the pawl 40 is set between the reversing member 30 and the rotatable member 20. Because the shaft portion 42 of the pawl 40 is accommodated in the receiving space 33 of the reversing member 30 between the first bearing surface 34 and the second bearing surface 35, the pawl 40 can be alternatively supported in two directions during operation of the ratchet wrench. Thus, the ratchet wrench in accordance has a better structural strength when compared to conventional designs, prolonging the lifespan.

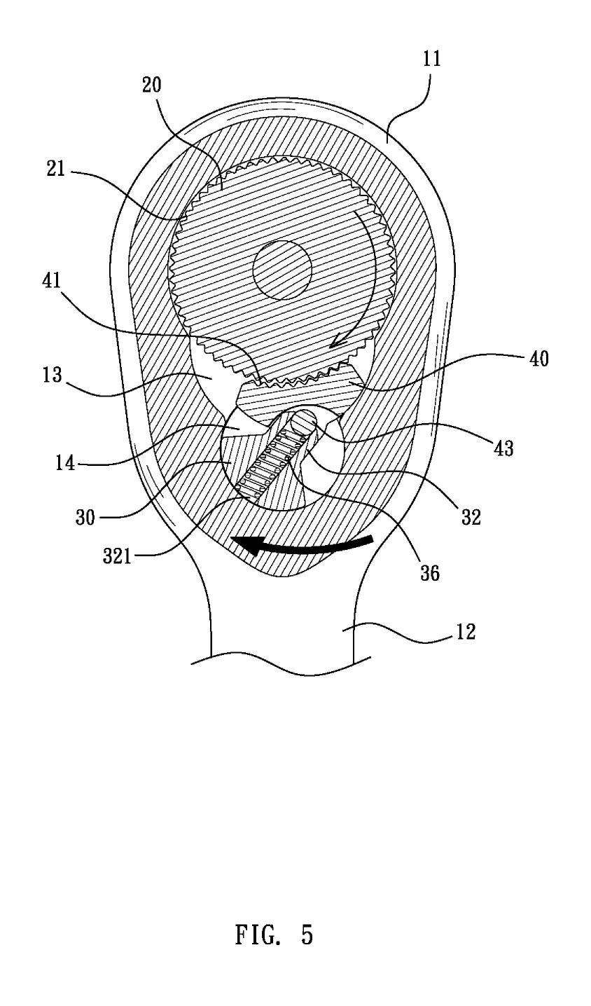

Referring to FIG. 5, if the reversing member 30 is rotated leftwards to the first position, the spring member 36 will be stopped at the left side of the locating pin 43 to force the right half of the toothed portion 41 of the pawl 40 into engagement with the sloping teeth 21 of the rotatable member 20, and thus, the rotatable member 20 can only be rotated clockwise at this time. When reversed, the ratchet wrench can only rotate a wrench socket counter-clockwise.

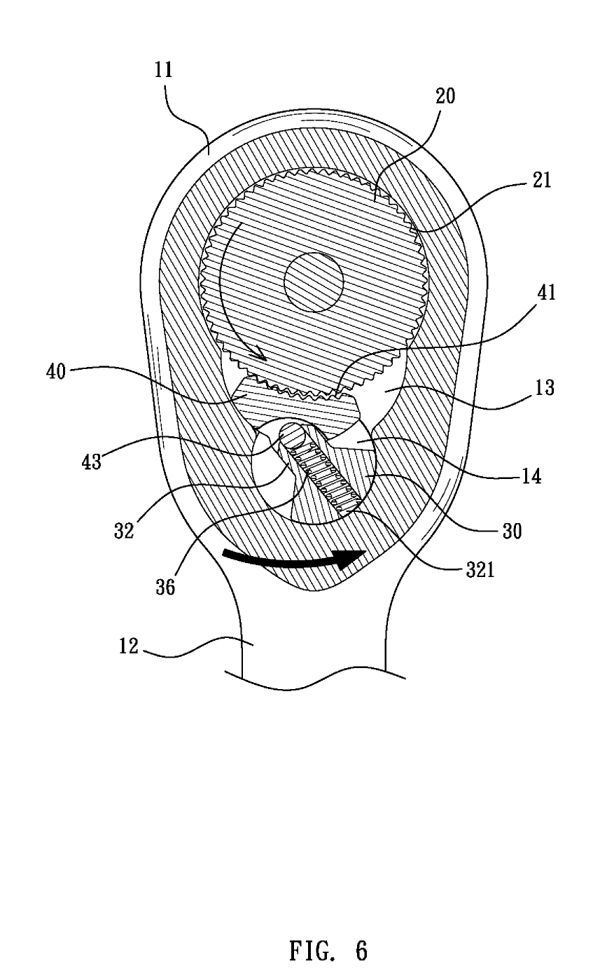

Referring to FIG. 6, if the reversing member 30 is rotated rightwards to the second position, the spring member 36 will be stopped at the left side of the locating pin 43 to force the left half of the toothed portion 41 of the pawl 40 into engagement with the sloping teeth 21 of the rotatable member 20, and thus, the rotatable member 20 can only be rotated counter-clockwise at this time. When reversed, the ratchet wrench can only rotate a wrench socket clockwise.

In conclusion, the arrangement of the locating pin at the backside of the pawl of the ratchet wrench enables the pawl to be positively supported on the spring member during reversing of the rotatable member. Subject to the arrangement of the locating pin, it is not necessary to process a part of the pawl into a cam surface by means of a complicated milling procedure, and therefore, the manufacturing cost of the ratchet wrench can be greatly reduced. Further, by means of accommodating the shaft portion of the pawl in the receiving space of the reversing member between the first bearing surface and the second bearing surface, the structural strength of the ratchet wrench is enhanced. When compared to conventional designs, the ratchet wrench of the invention has a better structural strength, prolonging the ratchet wrench lifespan.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A ratchet wrench, comprising:
a body comprising a head portion and a handle portion extended from one end of said head portion, said head portion defining therein a first cavity and a second cavity in communication with said first cavity;
a rotatable member rotatably accommodated in said first cavity, said rotatable member comprising a plurality of sloping teeth equiangularly spaced around the periphery thereof;
a reversing member pivotally mounted in said second cavity, said reversing member comprising opposing first bearing surface and second bearing surface;
a pawl set between said rotatable member and said reversing member, said pawl comprising a toothed portion located at one side thereof and a shaft portion located at an opposite side thereof and disposed between said first bearing surface and said second bearing surface, said pawl being movable by said reversing member between a first position where said toothed portion of said pawl is forced into engagement with said sloping teeth of said rotatable member and a second position where said toothed portion of said pawl is disengaged from said sloping teeth of said rotatable member; and
a cover covering said first cavity and said second cavity, said cover defining therein a through hole for the passing of said rotatable member to rotate a wrench socket forward or backward.

2. The ratchet wrench as claimed in claim 1, wherein said shaft portion of said pawl comprises an axle hole and a locating pin mounted in said axle hole; said reversing member comprises a fork located at a bottom side thereof and coupled to said locating pin.

3. The ratchet wrench as claimed in claim 2, wherein said second bearing surface is located at a topside of said fork.

4. The ratchet wrench as claimed in claim 2, wherein said reversing member comprises a transversely extending through hole, and a spring member accommodated in said transversely extending through hole and stopped between the periphery of said locating pin and an inside wall of said second cavity.

5. The ratchet wrench as claimed in claim 1, wherein said head portion of said body further comprises a locating groove located at a bottom side thereof, and a C-shaped retainer mounted in said locating groove to secure said cover in position and to prohibit said cover from falling out of said head portion of said body.

6. The ratchet wrench as claimed in claim 1, wherein said rotatable member comprises a coupling rod extended from a bottom side thereof for driving a wrench socket.

7. The ratchet wrench as claimed in claim 6, wherein rotatable member further comprises a steel ball mounted in one side of said coupling rod, and a release control rod located at a top side thereof and operable to move said steel ball between a locking position and a release position to secure or release a wrench socket.
